(19) United States
(12) Patent Application Publication
(10) Pub. No.: US 2025/0119596 A1
(43) Pub. Date: Apr. 10, 2025

(54) SYSTEM AND METHOD FOR MEDIA LIBRARY EVENT COMMUNICATION

(71) Applicant: Ademco Inc., Golden Valley, MN (US)

(72) Inventors: Lindsey Freitag, Saint Louis Park, MN (US); Brett Vandenbussche, Minneapolis, MN (US); Christopher Jones, Minneapolis, MN (US); Peter Anderholm, New Harbor, ME (US)

(73) Assignee: Ademco Inc., Golden Valley, MN (US)

(21) Appl. No.: 18/825,510

(22) Filed: Sep. 5, 2024

Related U.S. Application Data
(60) Provisional application No. 63/588,073, filed on Oct. 5, 2023.

(51) Int. Cl. H04N 21/231

(52) U.S. Cl. CPC H04N 21/23113

(57) ABSTRACT

Disclosed are systems and methods that provide a novel framework for automatically and dynamically managing a media (or content) library, and effectuating electronic controls and/or notifications related to events of stored files. The framework can i) receive an electronic instruction corresponding to a deletion action for a stored video clip; ii) analyze a datastore comprising an account of a user that includes a collection of video clips corresponding to captured activity at a location associated with the user; iii) locate the video clip within the datastore in association with the user account; iv) delete the video clip from the user account; and v) modify the datastore by automatically inputting a data structure in place of the video clip at a location within the datastore previously held by the video clip, where the data structure includes interactive information associated with the video clip.

### RELATED APPLICATION(S)

This application claims the benefit of priority from U.S. Provisional Patent Application No. 63/588,073, filed Oct. 5, 2023, the contents of which are incorporated herein by reference in their entirety.

### FILED OF THE DISCLOSURE

The present disclosure is generally related to media and/or library management, and more particularly, to a decision intelligence (DI)-based computerized framework for automatically and dynamically managing a media (or content) library, and effectuating electronic controls and/or notifications related to events of stored files.

### BACKGROUND

Conventional media libraries, as well as other digital/electronic data stores, store content in dedicated and mapped locations, and upon deletion of particular content files, all traces of the content files are removed.

### SUMMARY OF THE DISCLOSURE

To that end, this effectively renders any record of an event being removed from the recorded history of the application, platform and/or user experience. Thus, for example, another user on an account will not be apprised of the functionality for determining whether a file existed at all, and/or whether it was deleted in error, replaced and/or mistakenly remembered.

According to some embodiments, as discussed herein, the disclosed systems and methods provide a novel computerized framework that enables secure, accurate and efficient record keeping mechanisms to enable audit trails to be provided within a media/content library.

It should be understood that while the discussion herein may focus on a media library (e.g., a digital library of video clips, for example), it should not be construed as limiting, as the disclosed systems and methods for electronic record keeping and audit trail creation can be provided for any type of data/metadata that can be stored and/or retrieved from a storage location, such as, but not limited to, text, audio, video, multimedia, RSS feeds, and the like.

Accordingly, in some embodiments, upon a deletion event occurring respective to a media (or content, used interchangeably) file, instead of the entire clip component within the media library being removed, the disclosed framework can effectuate a modification to the media library record by creating a user interface object (IO) (or interface component or element) and having such IO inserted into the location from where the media file was previously located. In some embodiments, the new IO component may not include media artifacts, such as, for example, a thumbnail, type of motion event, and the like. Rather, in some embodiments, the IO component can include metadata related to the previously deleted media file—for example, origin, date, time, identifier (ID), and the like, which can enable the IO component to be differentiated from other IO components and/or media files within the media library, as discussed in more detail below. Thus, the IO component can enable the determination (e.g., by users, applications, platforms and/or any other requesting device and/or entity) that a media event had occurred and was deleted, thereby confirming an audit trail of events for a location.

By way of a non-limiting example, a location (e.g., a home) can be configured with a security system, which can include a doorbell camera. The camera can collect event clips which correspond to activities of people approaching the location's front door. Each event (or media) clip can be stored in a datastore (e.g., in a cloud location associated with an account of the location and/or resident user of the location, for example). Upon the user searching for and identifying a specific media event clip, the disclosed framework can determine metadata related to the event, and generate the IO component, which can be inserted into the now empty space in the media library. This can provide functionality for requesting entities, devices and/or users to discern and/or confirm that a specific event occurred, which can be predicated on the information within the IO component and/or the presence of the IO component.

According to some embodiments, a method is disclosed for a DI-based computerized framework for automatically and dynamically managing a media (or content) library, and effectuating notifications related to events related to stored files. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for automatically and dynamically managing a media (or content) library, and effectuating notifications related to events related to stored files.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 depicts an exemplary implementation of an architecture according to some embodiments of the present disclosure;

FIG. 5 depicts an exemplary implementation of an architecture according to some embodiments of the present disclosure; and

FIG. 6 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

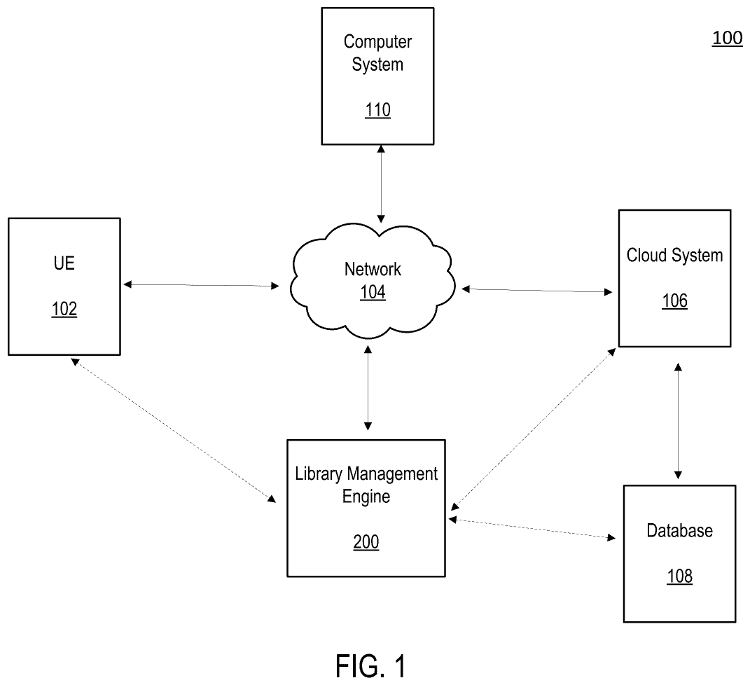

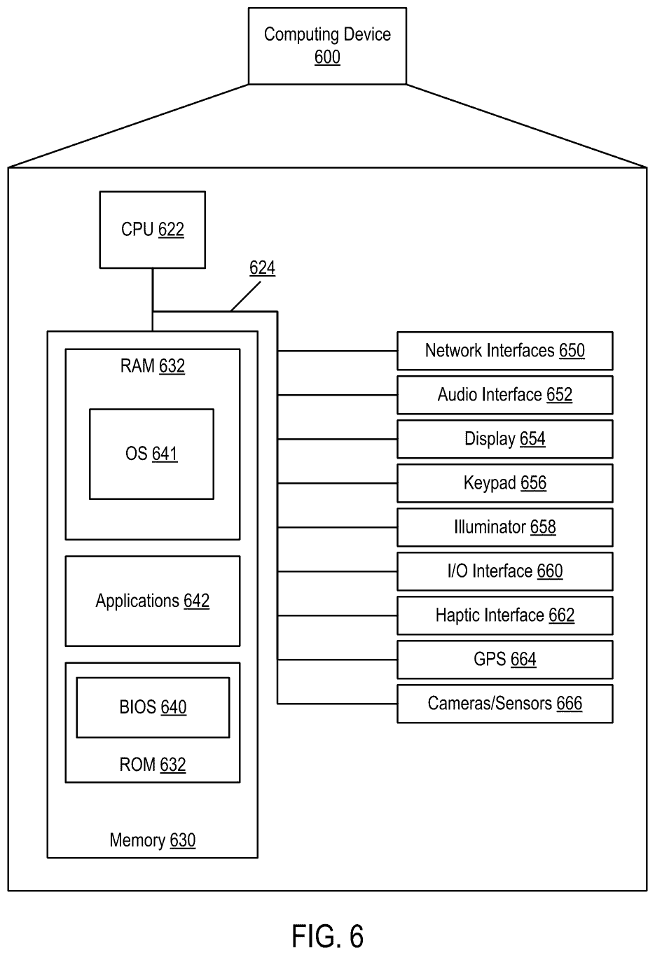

Certain embodiments and principles will be discussed in more detail with reference to the figures. With reference to FIG. 1, system 100 is depicted which includes user equipment (UE) 102 (e.g., a client device, as mentioned above and discussed below in relation to FIG. 6), network 104, cloud system 106, database 108, computer system 110 and library management engine 200. It should be understood that while system 100 is depicted as including such components, it should not be construed as limiting, as one of ordinary skill in the art would readily understand that varying numbers of UEs, cloud systems, databases, computer systems and/or networks can be utilized; however, for purposes of explanation, system 100 is discussed in relation to the example depiction in FIG. 1.

According to some embodiments, UE 102 can be any type of device, such as, but not limited to, a mobile phone, tablet, laptop, sensor, Internet of Things (IoT) device, autonomous machine, and any other device equipped with a cellular or wireless or wired transceiver.

In some embodiments, peripheral device (not shown) can be connected to UE 102, and can be any type of peripheral device, such as, but not limited to, a wearable device (e.g., smart watch), printer, speaker, sensor, and the like. In some embodiments, peripheral device can be any type of device that is connectable to UE 102 via any type of known or to be known pairing mechanism, including, but not limited to, WiFi, Bluetooth™, Bluetooth Low Energy (BLE), NFC, and the like. For example, the peripheral device can be a smart ring that connectively pairs with UE 102, which can be a user's smart phone.

According to some embodiments, computer system 110 can be any type of secure local and/or network device, location, application, account, portal, resource, and the like, upon which authentication is required for a device and/or user to access the securely held information. For example, computer system 100 can be, but is not limited to, a web-portal, website, application, account, datastore, repository, cloud, peer device, platform, exchange, and the like, or some combination thereof.

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with location monitoring and/or control system provider (e.g., Resideo®), which has associated network resources hosted on the internet or private network (e.g., network 104), which enables (via engine 200) the library and/or media management discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE 102, and the services and applications provided by cloud system 106 and/or library management engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

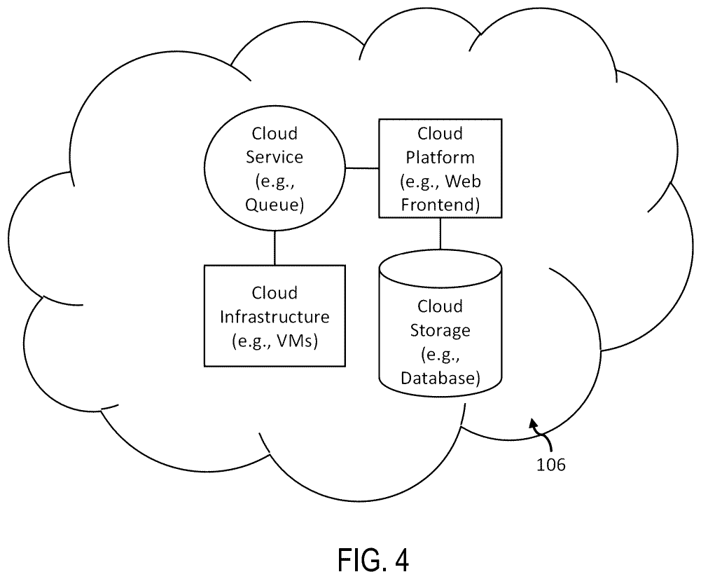

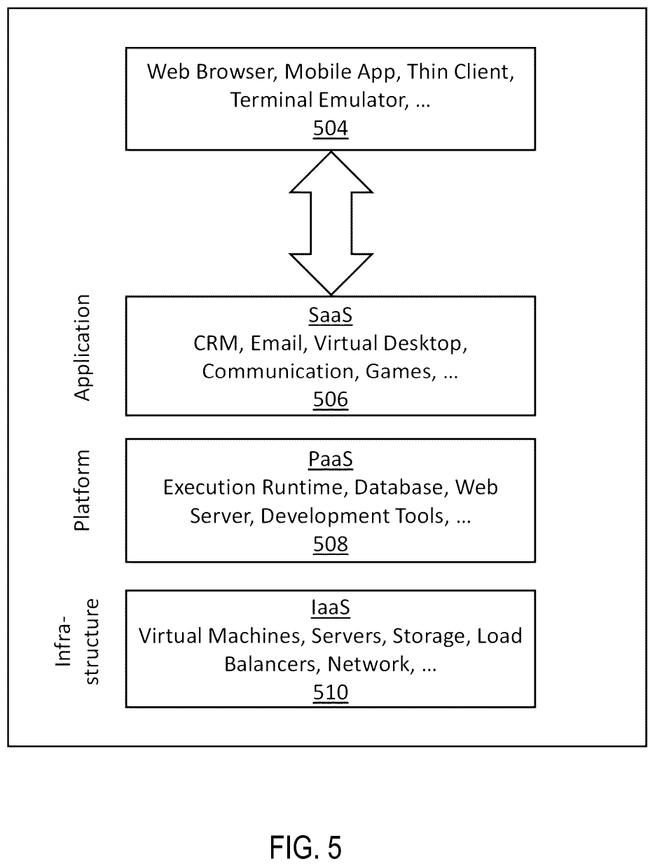

Turning to FIG. 4 and FIG. 5, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure as a service (IaaS) 510, platform as a service (PaaS) 508, and/or software as a service (SaaS) 506 using a web browser, mobile app, thin client, terminal emulator or other endpoint 504. FIG. 4 and FIG. 5 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository

Library management engine 200, as discussed above and further below in more detail, can include components for the disclosed functionality. According to some embodiments, library management engine 200 may be a special purpose machine or processor, and can be hosted by a device on network 104, within cloud system 106 and/or on UE 102. In some embodiments, engine 200 may be hosted by a server and/or set of servers associated with cloud system 106.

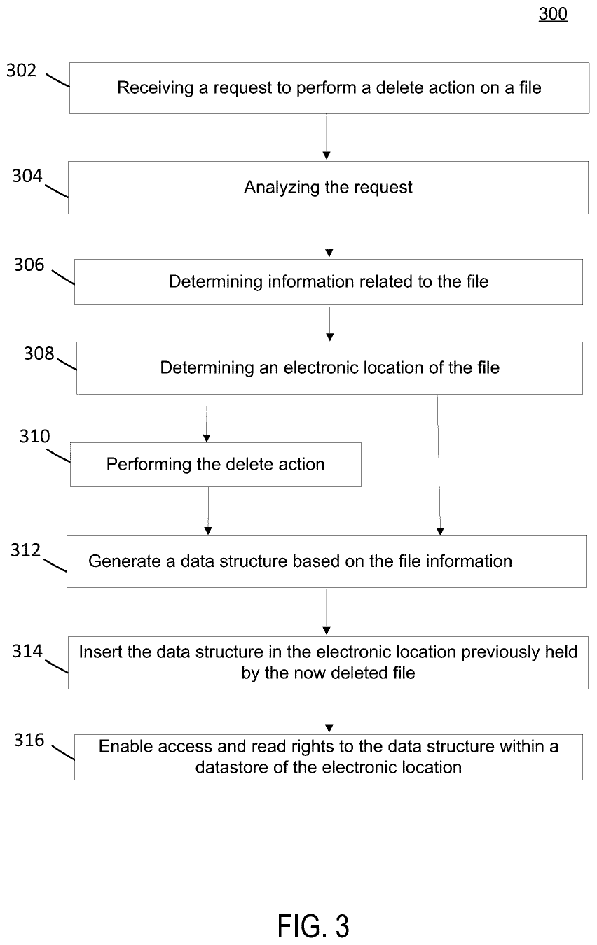

According to some embodiments, as discussed in more detail below, library management engine 200 may be configured to implement and/or control a plurality of services and/or microservices, where each of the plurality of services/microservices are configured to execute a plurality of workflows associated with performing the disclosed media management. Non-limiting embodiments of such workflows are provided below in relation to at least FIG. 3.

According to some embodiments, as discussed above, library management engine 200 may function as an application provided by cloud system 106. In some embodiments, engine 200 may function as an application installed on a server(s), network location and/or other type of network resource associated with system 106. In some embodiments, engine 200 may function as an application installed and/or executing on UE 102. In some embodiments, such application may be a web-based application accessed by UE 102 and/or other devices over network 104 from cloud system 106. In some embodiments, engine 200 may be configured and/or installed as an augmenting script, program or application (e.g., a plug-in or extension) to another application or program provided by cloud system 106 and/or executing on UE 102.

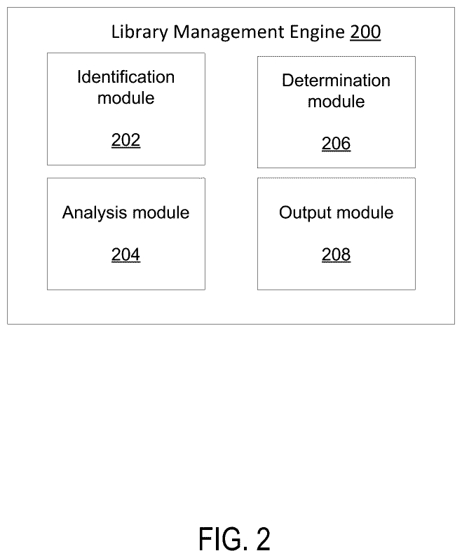

As illustrated in FIG. 2, according to some embodiments, library management engine 200 includes identification module 202, analysis module 204, determination module 206 and output module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

Turning to FIG. 3, Process 300 provides non-limiting example embodiments for the disclosed media and/or library management framework. According to some embodiments, Step 302 can be performed by identification module 202 of library management engine 200; Step 304 can be performed by analysis module 204; Steps 306 and 308 can be performed by determination module 206; and Steps 310-316 can be performed by output module 208.

According to some embodiments, Process 300 begins with Step 302 where engine 200 can receive a request to perform a delete action on a file. According to some embodiments, Step 302 can involve a search for a specifically stored file, which can include a search query defined by search terms and/or information related to, but not limited to, a file name, file type, date, location, date/time range, user captured in the file (e.g., which user is depicted in a video clip, for example), application type (e.g., which application captured the media for the file), and the like, or some combination thereof.

In some embodiments, the request can be provided by a user, an application, a device and/or a platform (e.g., computer system 110, discussed supra), and the like, In some embodiments, the request can be triggered via a time-to-live (TTL) trigger, which can correspond to a time-frame and/or life-span of stored files. For example, files older than 60 days can be identified for deletion based on a subscription account of the user.

Accordingly, in some embodiments, stored media files can be based on video clips captured by devices and/or sensors at the location. For example, such devices can include, but are not limited to, motion capture cameras, floodlight cameras, video doorbells, wired/wireless indoor/outdoor cameras, and the like,

As mentioned above, while the discussion herein may focus on captured video events, it should not be construed as limiting, as any type of event detection at a location can be implemented via the disclosed framework (e.g., engine 200) without departing from the scope of the instant disclosure—for example, events can be captured via sensors, such as, but not limited to, door and window contacts, temperature, heat and smoke detectors, passive infrared (PIR) sensors, time-of-flight (ToF) sensors, and the like. In some embodiments, such sensors can be associated with devices associated with the location, such as, for example, lights, smart locks, garage doors, smart appliances (e.g., thermostat, refrigerator, television, personal assistants (e.g., Alexa®, Nest®, for example)), smart rings, smart phones, smart watches or other wearables, tablets, personal computers, and the like, and some combination thereof.

Accordingly, in some embodiments, upon video events being captured, media (e.g., video clips) for such captured event data can be created and stored in a corresponding media library (e.g., database 108, discussed supra). In some embodiments, information related to the name, location and/or file type can be automatically generated, and in some embodiments, such information can be a product of input from an application, user and/or platform. In some embodiments, as discussed above respective database 108, such storage of the media file can be in accordance with an account of a user(s) and/or location (e.g., the security account for the home, for example).

In Step 304, upon receiving a request, engine 200 can analyze the request. In some embodiments, engine 200 can parse the request and extract (or determine) the information included therein that identifies the information related to the file, as in Step 306. In some embodiments, the file information from Step 306 can include, but is not limited to, a name, file type, requesting user ID, and the like, of the file identified in the request.

In Step 308, upon identifying the information for the requested file (as in Step 306), engine 200 can perform operations to determine the electronic location within the file. For example, the ID of the user can be leveraged to determine the account within the media library for the requesting user, whereby the name and/or other corresponding information for the file can then be leveraged to search for the file. By way of a non-limiting example, Step 308 can involve identifying the location within the LUT associated with the user's account for where the file is electronically located (e.g., stored).

In some embodiments, the determinations from Step 306 and/or Step 308 can be performed via engine 200 performing any type of known or to be known computational analysis technique, algorithm, mechanism or technology to perform the analysis of Step 304, which can include, but is not limited to, computer vision, feature vector analysis, decision trees, boosting, support-vector machines, neural networks, nearest neighbor algorithms, Naive Bayes, bagging, random forests, logistic regression, and the like.

In Step 310, engine 200 can then perform the requested delete action on the file, such that the file is removed/wiped from the determined electronic location. In some embodiments, for example, Step 310's deletion event can involve engine 200 executing a SQL or database command to delete the file from the media library (e.g., database 108). In some embodiments, depending on the type of the database system, the command may vary (e.g., DELETE statement in SQL). In some embodiments, for example the WHERE clause targets the files location (e.g., from Step 308), and the DELETE statement enables such deletion.

According to some embodiments, the deletion of Step 310 can further involve steps related to, but not limited to, access permissions, backups, audit trails and backup purging, and the like.

For example, Step 310 can involve engine 200 checking and determining whether the requesting user (from Step 302) (or application, entity or platform) has the necessary access permissions to delete the file.

In some embodiments, Step 310 may involve creating a backup in a local and/or remote storage location. In some embodiments, such backup may be purged or overwritten, which can occur upon the completion of Process 300, discussed infra.

In some embodiments, for databases that log all transactions, engine 200 can analyze the database to determine such functionality, and engage audit mechanisms to render the logs modified so as not to provide access to any backups of the deleted file. The logs, for example, can be created, updated and/or modified to indicate the deletion event, but provide no access or information related to the file. As provided below, the IO component enables diligence into the file that was deleted.

Continuing with Process 300, upon deletion of the file, processing can proceed to Step 312. In some embodiments, Step 312 can be performed during, after and/or in an overlapping manner (e.g., substantially simultaneously) with the delete action of Step 310.

In Step 312, engine 200 can create/generate a data structure (e.g., IO component, discussed supra) based on the file information. Thus, in some embodiments, engine 200 can leverage the information determined from Step 306 and Step 308, and compile an electronic IO component, that is a defined data structure. As discussed above, the IO component can include, but is not limited to, a name, creation date/time, deletion date/time, ID of event related to the file's creation, ID related to the delete action, ID of the requesting user, and the like, or some combination thereof.

In Step 314, the data structure related to the IO component can be inserted into the electronic location of the now deleted file. Such insertion can involve the further modification of the database and electronic location therein. In some embodiments, the insertion of Step 314 can correlate with the delete action, whereby the file can be overwritten via the created data structure.

And, in Step 316, engine 200 can enable access and read rights to the data structure within the media library. Such access/read rights can correspond to enabling a requesting user, application and/or platform to view the IO component as an interface element, which enables viewing, accessing and/or identification of the electronic information from the previously stored file that is digitally represented by the IO component.

FIG. 6 is a schematic diagram illustrating a client device showing an example embodiment of a client device that may be used within the present disclosure. Client device 600 may include many more or less components than those shown in FIG. 6. However, the components shown are sufficient to disclose an illustrative embodiment for implementing the present disclosure. Client device 600 may represent, for example, UE 102 discussed above at least in relation to FIG. 1.

As shown in the figure, in some embodiments, Client device 600 includes a processing unit (CPU) 622 in communication with a mass memory 630 via a bus 624. Client device 600 also includes a power supply 626, one or more network interfaces 650, an audio interface 652, a display 654, a keypad 656, an illuminator 658, an input/output interface 660, a haptic interface 662, an optional global positioning systems (GPS) receiver 664 and a camera(s) or other optical, thermal or electromagnetic sensors 666. Device 600 can include one camera/sensor 666, or a plurality of cameras/sensors 666, as understood by those of skill in the art. Power supply 626 provides power to Client device 600.

Client device 600 may optionally communicate with a base station (not shown), or directly with another computing device. In some embodiments, network interface 650 is sometimes known as a transceiver, transceiving device, or network interface card (NIC).

Audio interface 652 is arranged to produce and receive audio signals such as the sound of a human voice in some embodiments. Display 654 may be a liquid crystal display (LCD), gas plasma, light emitting diode (LED), or any other type of display used with a computing device. Display 654 may also include a touch sensitive screen arranged to receive input from an object such as a stylus or a digit from a human hand.

Keypad 656 may include any input device arranged to receive input from a user. Illuminator 658 may provide a status indication and/or provide light.

Client device 600 also includes input/output interface 660 for communicating with external. Input/output interface 660 can utilize one or more communication technologies, such as USB, infrared, Bluetooth™, or the like in some embodiments. Haptic interface 662 is arranged to provide tactile feedback to a user of the client device.

Optional GPS transceiver 664 can determine the physical coordinates of Client device 600 on the surface of the Earth, which typically outputs a location as latitude and longitude values. GPS transceiver 664 can also employ other geo-positioning mechanisms, including, but not limited to, triangulation, assisted GPS (AGPS), E-OTD, CI, SAI, ETA, BSS or the like, to further determine the physical location of client device 600 on the surface of the Earth. In one embodiment, however, Client device 600 may through other components, provide other information that may be employed to determine a physical location of the device, including for example, a MAC address, Internet Protocol (IP) address, or the like.

Mass memory 630 includes a RAM 632, a ROM 634, and other storage means. Mass memory 630 illustrates another example of computer storage media for storage of information such as computer readable instructions, data structures, program modules or other data. Mass memory 630 stores a basic input/output system (“BIOS”) 640 for controlling low-level operation of Client device 600. The mass memory also stores an operating system 641 for controlling the operation of Client device 600.

Memory 630 further includes one or more data stores, which can be utilized by Client device 600 to store, among other things, applications 642 and/or other information or data. For example, data stores may be employed to store information that describes various capabilities of Client device 600. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 600.

Applications 642 may include computer executable instructions which, when executed by Client device 600, transmit, receive, and/or otherwise process audio, video, images, and enable telecommunication with a server and/or another user of another client device. Applications 642 may further include a client that is configured to send, to receive, and/or to otherwise process gaming, goods/services and/or other forms of data, messages and content hosted and provided by the platform associated with engine 200 and its affiliates.

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
receiving, by a device, an electronic instruction corresponding to a deletion action for a stored video clip;
analyzing, by the device, over a network, a datastore comprising an account of a user, the account comprising a collection of video clips corresponding to captured activity at a location associated with the user;
locating, by the device, based on the analysis, the video clip within the datastore in association with the user account;
deleting, by the device, the video clip from the user account; and
modifying, by the device, based on the deletion, the datastore by automatically inputting a data structure in place of the video clip at a location within the datastore previously held by the video clip, the data structure comprising information associated with the video clip, the data structure being a file that is capable of being located, extracted and viewed from the datastore.

2. The method of claim 1, further comprising:
capturing, by a camera associated with the device, the video clip;
determining, by the device, the information associated with the video clip; and
storing, in the datastore, in association with the account of the user, the video clip and the information associated with the video clip.

3. The method of claim 1, wherein the information associated with the video clip comprises information related to an origin of the video clip, date and time, wherein the information is configured as metadata for the video clip.

4. The method of claim 1, wherein the electronic instruction is related to at least one of a user input for performing the deletion action, and an automatically generated instruction, wherein the automatically generated instruction is based on at least one of a time, date, activity, event and account setting.

5. The method of claim 1, wherein the delete action comprises overwriting the video clip with the data structure.

6. The method claim 1, further comprising:
creating, based on the information associated with the video clip, the data structure, the data structure being an interface object (IO) configured to be inserted in the datastore at the location.

7. The method of claim 1, further comprising:
creating a backup of video clip; and
purging, upon performance of the input of the data structure, the backup of the video clip.

8. The method of claim 1, wherein the datastore is a media library.

9. A system comprising:
a processor configured to:
receive an electronic instruction corresponding to a deletion action for a stored video clip;
analyze, over a network, a datastore comprising an account of a user, the account comprising a collection of video clips corresponding to captured activity at a location associated with the user;
locate, by the device, based on the analysis, the video clip within the datastore in association with the user account;
delete, by the device, the video clip from the user account; and
modify, based on the deletion, the datastore by automatically inputting a data structure in place of the video clip at a location within the datastore previously held by the video clip, the data structure comprising information associated with the video clip, the data structure being a file that is capable of being located, extracted and viewed from the datastore.

10. The system of claim 9, wherein the information associated with the video clip comprises information related to an origin of the video clip, date and time, wherein the information is configured as metadata for the video clip.

11. The system of claim 9, wherein the electronic instruction is related to at least one of user input for performing the deletion action and an automatically generated instruction, wherein the automatically generated instruction is based on at least one of a time, date, activity, event and account setting.

12. The system of claim 9, wherein the delete action comprises overwriting the video clip with the data structure.

13. The system claim 9, wherein the processor is further configured to:
create, based on the information associated with the video clip, the data structure, the data structure being an interface object (IO) configured to be inserted in the datastore at the location.

14. The system of claim 9, wherein the processor is further configured to:
create a backup of video clip; and
purge, upon performance of the input of the data structure, the backup of the video clip.

15. A non-transitory computer-readable storage medium tangibly encoded with computer-executable instructions that when executed by a device, perform a method comprising:
receiving, by the device, an electronic instruction corresponding to a deletion action for a stored video clip;
analyzing, by the device, over a network, a datastore comprising an account of a user, the account comprising a collection of video clips corresponding to captured activity at a location associated with the user;
locating, by the device, based on the analysis, the video clip within the datastore in association with the user account;
deleting, by the device, the video clip from the user account; and
modifying, by the device, based on the deletion, the datastore by automatically inputting a data structure in place of the video clip at a location within the datastore previously held by the video clip, the data structure comprising information associated with the video clip, the data structure being a file that is capable of being located, extracted and viewed from the datastore.

16. The non-transitory computer-readable storage medium of claim 15, wherein the information associated with the video clip comprises information related to an origin of the video clip, date and time, wherein the information is configured as metadata for the video clip.

17. The non-transitory computer-readable storage medium of claim 15, wherein the electronic instruction is related to at least one of user input for performing the deletion action and an automatically generated instruction, wherein the automatically generated instruction is based on at least one of a time, date, activity, event and account setting.

18. The non-transitory computer-readable storage medium of claim 15, wherein the delete action comprises overwriting the video clip with the data structure.

19. The non-transitory computer-readable storage medium claim 15, further comprising:
creating, based on the information associated with the video clip, the data structure, the data structure being an interface object (IO) configured to be inserted in the datastore at the location.

20. The non-transitory computer-readable storage medium of claim 15, further comprising:
creating a backup of video clip; and
purging, upon performance of the input of the data structure, the backup of the video clip.
